(19) United States
(12) Patent Application Publication
(10) Pub. No.: US 2025/0161883 A1
(43) Pub. Date: May 22, 2025

(54) POROUS HOLLOW FIBER MEMBRANE AND METHOD FOR PRODUCING POROUS HOLLOW FIBER MEMBRANE

(71) Applicant: ASAHI KASEI KABUSHIKI KAISHA, Tokyo (JP)

(72) Inventors: Norihito TANAKA, Tokyo (JP); Yuki MIKI, Tokyo (JP)

(73) Assignee: ASAHI KASEI KABUSHIKI KAISHA, Tokyo (JP)

(21) Appl. No.: 18/953,113

(22) Filed: Nov. 20, 2024

(30) Foreign Application Priority Data
Nov. 21, 2023 (JP) 2023-197728

(51) Int. Cl. B01D 69/08; B01D 67/00; B01D 69/02; B01D 71/34

(52) U.S. Cl. CPC B01D 69/08; B01D 67/0018; B01D 67/0027; B01D 67/003; B01D 69/02; B01D 71/34; B01D 2323/20; B01D 2323/24; B01D 2323/30; B01D 2323/34

(57) ABSTRACT

The present disclosure provides a porous hollow fiber membrane that exhibits blocking performance and water permeability performance suitable for filtration applications, as well as having excellent chemical resistance. In order to provide a solution to the above issue, the porous hollow fiber membrane of the present disclosure is made of a thermoplastic resin, wherein the crystallization onset temperature is 140° C. or lower, and the enthalpy of crystal fusion at and below the crystallization onset temperature is 10 J/g or less.

### TECHNICAL FIELD

The present disclosure relates to a porous hollow fiber membrane and a method for producing a porous hollow fiber membrane.

### BACKGROUND

Water treatment using membrane separation technology has been widely utilized in various industrial fields such as pharmaceuticals, medical care, food, semiconductors, and water supply and sewage systems.

In recent years, its applications have increasingly expanded to areas such as the field of water treatment, where river water and water from other sources are clarified to produce drinking water and industrial water, as well as the field of wastewater treatment, where domestic and industrial wastewater, etc. is clarified and purified.

Examples of filtration materials for membrane separation include hollow fiber membranes formed by a shaping polymer resin with excellent processability into hollow tubes or flat membranes shaped into sheets, which are assembled to be used as membrane modules.

Among these, particularly porous hollow fiber membranes used for removing turbidity from river water or seawater are required to have high water permeability and blocking performance because they are used to process large volumes of water. Furthermore, since the external pressure filtration method is adopted to increase filtration efficiency, hollow fiber membranes need to have compressive strength to prevent collapse due to external pressure during filtration operations.

Additionally, when hollow fiber membranes are continuously used for water treatment, blockages occur on the membrane surfaces due to substances separated during filtration, and the water permeability is reduced. Therefore, cleaning of the hollow fiber membranes is performed periodically after a certain amount of water is filtrated, and the periodic cleaning involves the removal of accumulated organic substances, etc. on the membrane surface using chemical substances.

However, such chemical cleaning not only removes the accumulated organic substances but also degrades the polymer constituting the hollow fiber membrane. As a result, repeated chemical cleaning gradually degrades the hollow fiber membranes, preventing continuous long-term operation of the hollow fiber membrane module. Thus, hollow fiber membranes also need to have high chemical resistance.

For example, PTLs 1 and 2 propose hollow fiber membranes that achieve both high water permeability performance and membrane strength, as well as having excellent blocking performance.

However, even if the membrane has high strength at the initial stage of operation, it is uncertain whether it can fully withstand repeated chemical cleaning.

Meanwhile, as a method for producing membranes, the thermally induced phase separation (TIPS) method is known. In this production method, a thermoplastic resin and an organic liquid material are used. The organic liquid material used does not dissolve the thermoplastic resin at room temperature but dissolves it at high temperatures, functioning as a latent solvent. The thermoplastic resin and the organic liquid material are kneaded at high temperatures to dissolve the thermoplastic resin into the organic liquid material, which is then cooled to room temperature to induce phase separation, and thereafter the organic liquid material is removed to produce a porous structure. This production method, particularly when the thermoplastic resin is a crystalline resin, has the advantage of promoting crystallization and obtaining high-strength membranes due to rapid cooling and solidification to form membranes after dissolution at high temperatures. The method is thus widely used as a method for producing porous membranes.

### CITATION LIST

### Patent Literature

PTL 1: JP 5717987 B
PTL 2: JP 6824284 B

### SUMMARY

The present disclosure is directed to providing a porous hollow fiber membrane that exhibits blocking performance and water permeability performance suitable for filtration applications, as well as having excellent chemical resistance, and a method for producing a porous hollow fiber membrane.

### Means for Solving the Problem

The present inventors have conducted extensive studies to provide a solution to the above issue and have completed the present disclosure. That is, the present disclosure is as follows.
[1] A porous hollow fiber membrane made of a thermoplastic resin,
   wherein a crystallization onset temperature is 140° C. or lower, and an enthalpy of crystal fusion at and below the crystallization onset temperature is 10 J/g or less.
[2] The hollow fiber membrane according to [1], wherein the enthalpy of crystal fusion of the entire porous hollow fiber membrane is less than 58 J/g.
[3] The hollow fiber membrane according to [1] or [2], wherein the enthalpy of crystal fusion of a peak appearing on a high temperature side of a crystal fusion main peak of the porous hollow fiber membrane is 0.1 J/g or more.
[4] The hollow fiber membrane according to any one of [1] to [3], wherein a temperature of the peak appearing on the high temperature side of the crystal fusion main peak of the porous hollow fiber membrane is at least 10° C. higher than a temperature of the crystal fusion main peak.
[5] The hollow fiber membrane according to any one of [1] to [4], wherein a degree of crystallinity of the porous hollow fiber membrane is less than 60%.
[6] The hollow fiber membrane according to [1], wherein the enthalpy of crystal fusion at and below the crystallization onset temperature is 15% or less of the enthalpy of crystal fusion of the entire porous hollow fiber membrane.
[7] The hollow fiber membrane according to any one of [2] to [6], wherein a weight average molecular weight (Mw) of the thermoplastic resin is 400 kDa or less.
[8] The hollow fiber membrane according to any one of [1] to [7], wherein the thermoplastic resin comprises a polyvinylidene fluoride-based resin.
[9] The hollow fiber membrane according to any one of [1] to [8], wherein the porous hollow membrane has an inner diameter of less than 0.75 mm and a compressive strength of 0.3 MPa or more.
[10] The hollow fiber membrane according to any one of [1] to [9], wherein the porous hollow fiber membrane has a percent of reverse units of 9% or more.
[11] A method for producing the hollow fiber membrane according to any one of [1] to [10] comprising a multi-stage heat treatment step in which, after stretching the hollow fiber membrane, a heat treatment is performed at a temperature 50° C. to 40° C. lower than a melting point of a thermoplastic resin comprising a polyvinylidene fluoride-based resin, followed by a heat treatment at a temperature 35° C. to 25° C. lower than the melting point of the thermoplastic resin.
[12] The method for producing according to [11], wherein the porous hollow fiber membrane is produced by melt-kneading a three-component mixture comprising the thermoplastic resin, an organic liquid material, and inorganic fine powder, extruding the mixture into hollow fibers, and then extracting the organic liquid material and the inorganic fine powder.

### Effects of the Invention

According to the present disclosure, it is possible to provide a porous hollow fiber membrane which is produced by the TIPS method, has high water permeability as well as blocking performance, and also exhibits high chemical resistance, allowing for continuous operation over a long period, and a method for producing a porous hollow fiber membrane.

### BRIEF DESCRIPTION OF THE DRAWINGS

In the accompanying drawings:

FIG. 1 is a schematic diagram illustrating a three-dimensional network structure;

FIG. 2 is a schematic diagram illustrating the configuration of an apparatus for producing a porous hollow fiber membrane;

FIG. 3 is a graph indicating the results of the total heat flow analyses for the samples of examples and comparative examples; and

FIG. 4 is a graph indicating the results of the non-reversing heat flow analyses for the samples of the examples and comparative examples.

### DETAILED DESCRIPTION

In the following, an embodiment for carrying out the present disclosure will be described in detail. The present disclosure is not limited to the following present embodiment and may be modified in various ways within the scope thereof.

### <Porous Hollow Fiber Membrane>

A porous hollow fiber membrane of the present disclosure (hereinafter sometimes simply referred to as “hollow fiber membrane”) is made of a thermoplastic resin.

Here, the thermoplastic resin preferably contains a fluorine-based resin, and may consist solely of a fluorine-based resin.

The fluorine-based resin preferably contains at least one selected from the group consisting of vinylidene fluoride resin (PVDF), chlorotrifluoroethylene resin, tetrafluoroethylene resin, ethylene-tetrafluoroethylene copolymer (ETFE), ethylene-monochlorotrifluoroethylene copolymer (ECTFE), hexafluoropropylene resin, and mixtures of these resins, and may consist solely of at least one selected from the group consisting of vinylidene fluoride resin (PVDF), chlorotrifluoroethylene resin, tetrafluoroethylene resin, ethylene-tetrafluoroethylene copolymer (ETFE), ethylene-monochlorotrifluoroethylene copolymer (ECTFE), hexafluoropropylene resin, and mixtures of these resins.

Among these, the thermoplastic resin preferably contains at least one of a vinylidene fluoride-based resin and a chlorotrifluoroethylene-based resin, and more preferably contains at least a vinylidene fluoride-based resin.

The term “vinylidene fluoride-based resin” means that the resin contains a homopolymer and/or copolymer of vinylidene fluoride. A vinylidene fluoride copolymer is a polymer having a residual structure of vinylidene fluoride. Typically, it is a copolymer of vinylidene fluoride monomers and other fluorine-based monomers, and publicly known copolymers may be selected and used as appropriate. Additionally, multiple types of vinylidene fluoride copolymers may be included.

In view of its excellent strength, the vinylidene fluoride-based resin is preferably a homopolymer. If it is a copolymer, the content of vinylidene fluoride is preferably 50% or more by molar ratio from the same viewpoint.

The thermoplastic resin may be of a single type, or it may be a combination of multiple types.

Furthermore, the crystallization onset temperature of the porous hollow fiber membrane of the present disclosure is 140° C. or lower, preferably 100° C. or higher and 140° C. or lower, and more preferably 120° C. or higher and 140° C. or lower.

Additionally, the enthalpy of crystal fusion at and below the crystallization onset temperature of the porous hollow fiber membrane of the present disclosure is preferably low, specifically, it needs to be 10 J/g or less.

Here, the crystallization onset temperature, enthalpy of crystal fusion, etc. can be analyzed using modulated DSC (MDSC). Unlike conventional DSC measurements, which involve constant heating rates, MDSC is a method in which a DSC measurement is performed while periodically increasing or decreasing the average heating rate. By performing an MDSC measurement, the heat flow obtained from conventional DSC can be separated into the reversing heat flow component, which can follow the periodical temperature increase or decrease, and the non-reversing heat flow component, which cannot follow the periodical temperature increase or decrease. The heat of crystal fusion is observed in the reversing heat flow, while crystallization is observed only in the non-reversing heat flow. Therefore, performing an MDSC measurement is one preferable embodiment for separately evaluate crystal fusion and crystallization.

The crystallization onset temperature is determined from the non-reversing heat flow, which will be described later.

The porous hollow fiber membrane of the present disclosure is a hollow fiber membrane containing a small amount of microcrystals that fuse at temperatures lower than or equal to the crystallization onset temperature, thereby possessing the characteristic of the polymer being prone to recrystallization. The imperfection of polymer crystals results from the crystal size (thickness of the crystal lamellae), and the melting point increases as the crystal size increases, whereas the melting point decreases as the crystal size decreases.

Here, the enthalpy of crystal fusion at and below the crystallization onset temperature corresponds to the microcrystalline regions that fuse at low temperatures. By minimizing these microcrystalline regions through heat treatments, a stable structure resistant to heat and chemical agents is achieved. As a result, even with lower molecular weight or crystallinity, a durable hollow fiber membrane can be obtained. Therefore, the enthalpy of crystal fusion needs to be 10 J/g or less.

In general, the crystal size of a polymer has a distribution depending on the production method, such as the polymerization method. When comparing hollow fiber membranes produced under the same conditions, the crystal size is often influenced by the characteristics of the polymer per se.

Typically, polymers with a wide distribution of crystal sizes are affected by the smaller microcrystalline regions with smaller sizes, which results in greater degradation and deviation in strength after immersion in a chemical agent, etc., and the membrane performances tend to deteriorate.

The porous hollow fiber membrane of the present disclosure uses a polymer with a wide distribution of crystal sizes. When heat treatments are performed on a hollow fiber membrane made from this polymer, microcrystals with small crystalline sizes (i.e., with low melting points) are converted into larger crystals (recrystallization). As a result, the proportion of microcrystals is reduced, thereby improving chemical resistance.

However, it is presumed that excellent chemical resistance may not be achieved in the following two cases.
1) If there are many crystals with melting points close to the heat treatment temperature, even when the melting points are at or below the heat treatment temperature, it takes time for the crystals to fuse, and the conversion to larger crystals is not significantly induced.
2) When there are many crystals with sizes whose melting points are equal to or higher than the heat treatment temperature, and the crystal size distribution is narrow, the crystals cannot be converted into larger crystals through heat treatment.

Furthermore, in the porous membrane of the present embodiment, the presence of a crystallization onset temperature at or below the heat treatment temperature (140° C. or lower in the present disclosure) indicates that small crystals remained in the porous hollow fiber membrane before the heat treatments. Based on this principle, small crystals can be converted into larger crystals through heat treatments.

On the other hand, if the crystallization temperature is higher than the heat treatment temperature, it indicates that there are no small crystals with melting points at or below the heat treatment temperature, and thus, larger crystals cannot be formed. Therefore, in the porous hollow fiber membrane of the present disclosure, if the crystallization onset temperature of the membrane is 140° C. or lower, recrystallization can be easily promoted and the enthalpy of crystal fusion at and below the crystallization onset temperature can be reduced to 10 J/g or less.

Note that the crystallization onset temperature is preferably 120° C. or higher. This is because, if crystals of which crystallization onset temperature is lower than 100° C. remain, the crystal structure may be changed under actual usage conditions, which is undesirable.

The enthalpy of crystal fusion of the porous hollow fiber membrane of the present disclosure is preferably less than 60 J/g, more preferably less than 58 J/g. As mentioned earlier, by restricting the number of microcrystals, the enthalpy of crystal fusion in this region decreases, making it possible to ensure a certain level of durability even when the ratio of crystals is small.

Additionally, the enthalpy of crystal fusion at and below the crystallization onset temperature is preferably fairly small relative to the overall enthalpy of crystal fusion, and is preferably 20% or less, and more preferably 15% or less.

Furthermore, the porous hollow fiber membrane of the present disclosure has the characteristic of being prone to recrystallization, and when the temperature is raised to the recrystallization temperature or higher, a crystalline phase having a melting point higher than the crystal fusion main peak is formed. The enthalpy of crystal fusion of this crystalline phase is preferably as high as possible to stabilize the structure, and preferably appears on the higher temperature side of the crystal fusion main peak. Specifically, it is preferably higher by 0.1 J/g or more, and by 10° C. or more.

Here, a porous hollow fiber membrane prone to recrystallization refers to a membrane with a wide distribution of crystal sizes and a large number of smaller microcrystalline regions with smaller crystalline sizes. It is considered that the microcrystalline regions with low melting points undergo recrystallization through the heat treatments, converted to larger crystals with higher melting points, which stabilizes the membrane structure.

Furthermore, the degree of crystallinity of the porous hollow fiber membrane of the present disclosure is preferably 30% or more and less than 70%. Since the porous hollow fiber membrane of the present disclosure contains a small number of microcrystals and has thick lamellae, a degree of crystallinity of 30% or more can prevent a reduction in membrane strength due to chemical erosion. The degree of crystallinity is more preferably 35% or more, and even more preferably 40% or more.

On the other hand, by keeping the degree of crystallinity less than 70%, the membrane does not become too brittle, making the membrane less susceptible to damage from deformation caused by pressure during filtration. The degree of crystallinity is more preferably less than 65%, and even more preferably less than 60%.

Furthermore, the weight average molecular weight (Mw) of the porous hollow fiber membrane of the present disclosure is preferably 100,000 or more and 500,000 or less, and more preferably 200,000 or more and 400,000 or less. If the Mw is less than 100,000, the mechanical strength of the resulting membrane is reduced. Conversely, if a high-molecular weight polymer with a molecular weight of more than 500,000 is used, the tensile elongation at break of the membrane decreases, and the viscosity when dissolved in the organic liquid material becomes high, which extends the time required for phase separation and results in tendency to reduce the water permeability performance. Additionally, since high-molecular weight polymers have poorer solubility, they are difficult to dissolve uniformly in the organic liquid material, leading to issues of unstable quality.

In addition, the porous hollow fiber membrane of the present disclosure preferably contains some proportion of heterosequences because this helps to obtain a hollow fiber membrane with high chemical resistance. Specifically, the heterosequence ratio in the molecule as measured by 1H-NMR is preferably 9.0% or more.

The porous hollow fiber membrane of the present disclosure preferably has an inner diameter of 0.4 mm or more and less than 5 mm. If the inner diameter is 0.4 mm or more, the excessive pressure loss in the liquid flowing through the hollow fiber membrane can be prevented, and if the inner diameter is less than 1 mm, sufficient compressive strength, and burst strength can more likely to be achieved even when the thickness is small. The inner diameter is more preferably 0.5 mm or more and less than 0.8 mm.

Additionally, the thickness is preferably 0.1 mm or more and 1.0 mm or less. If the thickness is 0.1 mm or more, sufficient compressive strength and burst strength can be more likely to be achieved, and if the thickness is 1.0 mm or less, the filtration resistance remains low, allowing for sufficient water permeability performance in practical use. The thickness is more preferably 0.15 mm or more and 0.25 mm or less.

Furthermore, the porous hollow fiber membrane of the present disclosure preferably has a pure water permeability of 1000 L/m²/h or more per unit membrane area based on the inner surface of the hollow fiber membrane, when pure water at 25° C. is passed through under a filtration pressure of 0.1 MPa. The pure water used for this measurement is distilled water or water filtered through an ultrafiltration membrane or reverse osmosis membrane with a molecular weight cutoff of 10,000 or lower.

If the pure water permeability is low, a larger number of membrane modules are required to process a given volume of water within a certain time, which increases the space occupied by the filtration system. Although it is possible to process the same volume of water within a given time by increasing the filtration pressure to avoid an increase in the occupied space, this would require higher pressure resistance for the membrane module and would also increase the energy costs required for filtration, which reduces the productivity.

From these viewpoints, the pure water permeability is preferably high. Specifically, the pure water permeability is preferably 1000 L/m²/h or more, more preferably 2000 L/m²/h or more, and even more preferably 3000 L/m²/h or more.

Additionally, the tensile elongation at break of the porous hollow fiber membrane of the present disclosure is preferably 30% or more and 240% or less. If the tensile elongation at break is less than 30%, there is a high risk of breakage of the membrane when forcibly swayed during cleaning of the membrane module, such as by flushing or air scrubbing. If it is greater than 300%, the compressive strength and burst strength tend to be decreased. The tensile elongation at break is more preferably 40% or more and 220% or less.

For chemical resistance, in addition to the absolute value of the tensile elongation at break, a retention rate thereof compared to the initial value is also important. The retention rate is preferably 60% or more, and more preferably 70% or more, assuming long-term use.

The porous hollow fiber membrane of the present disclosure is primarily used in the external pressure filtration method for increasing the filtration area. Therefore, the hollow fiber membrane needs to have sufficient strength in the direction of the external pressure to withstand compression by the external pressure during filtration operations, and the compressive strength is preferably 0.3 MPa or higher. If the compressive strength is 0.3 MPa or higher, the hollow fiber membrane can continuously maintain its shape in water treatment applications where operational pressure is applied for extended periods.

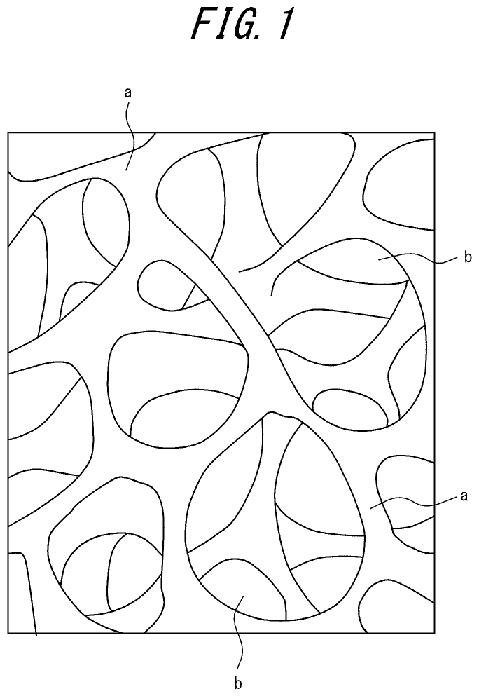

It is preferable that the porous hollow fiber membrane of the present disclosure is porous and has a three-dimensional network structure. In the present disclosure, a three-dimensional network structure is a structure as schematically illustrated in FIG. 1. For example, thermoplastic resin “a” is fused to form a network structure to thereby form voids “b”.

In the three-dimensional network structure, so-called spherulitic structures of resin masses are hardly observed. The voids “b” in the three-dimensional network structure are surrounded by the thermoplastic resin “a”, and it is preferable that each part of the voids “b” is interconnected. Since most of the thermoplastic resin used forms the three-dimensional network structure that can contribute to the strength of the hollow fiber membrane, a highly durable support layer can be formed. The chemical resistance is also improved. Although the reason for improved chemical resistance is not entirely clarified, it is considered that even if part of the network is degraded by a chemical agent, the strength of the entire layer is not significantly affected due to the large amount of the thermoplastic resin that can contribute to the network.

The hollow fiber membrane may have a single-layer structure or a multilayer structure with two or more layers. The layer with the surface on the feed side of the fluid to be filtered is designated as the layer (A), while the layer with the surface on the filtrate side is designated as the layer (B).

These layers have different functions. For example, the layer (A) may function as a so-called blocking layer that prevents the passage of foreign substances in the feed liquid (raw water) through the membrane due to its small surface pore sizes, while the layer (B) may serve as a support layer, assuring high mechanical strength without significantly reducing permeability. The functions of the layers (A) and (B) are not limited to the above-described combination.

The explanation below pertains to the case where the hollow fiber membrane has a multilayer structure, with the layer (A) functioning as a blocking layer and the layer (B) serving as a support layer in a two-layer structure.

The thickness of the layer (A), which is the layer forming the surface on the side of the fluid to be filtered, is preferably 1/100 or more and less than 40/100 of the total thickness of the membrane. By making the layer (A) relatively thick, the membrane can be used even if the raw water contains insoluble materials such as sand or aggregates. This is because the surface pore sizes do not change even if some wear occurs. Within this thickness range, a balance between desirable blocking performance and high water permeability performance can be achieved. More preferably, the thickness of the layer (A) is 2/100 or more and 30/100 or less of the thickness. The thickness of the layer (A) is preferably 1 μm or more and 100 μm or less, more preferably 2 μm or more and 80 μm or less.

### <Method for Producing Porous Hollow Fiber Membrane>

The method for producing a porous hollow fiber membrane of the present embodiment comprises steps of extruding a melt-kneaded product containing a thermoplastic resin, an organic liquid material, and inorganic fine powder through a spinning nozzle with an annular discharge outlet to form a hollow fiber-like melt-kneaded product, and then solidifying the hollow fiber-like melt-kneaded product, followed by extracting and removing the organic liquid material and the inorganic fine powder to fabricate a porous membrane (preferably a porous hollow fiber membrane).

The melt-kneaded product may consist of two components: a thermoplastic resin and a solvent, or three components: a thermoplastic resin, inorganic fine powder, and a solvent.

The thermoplastic resin used in the method for producing a porous hollow fiber membrane of the present embodiment is the same as that used for the porous hollow fiber membrane of the present embodiment described above.

Additionally, the thermoplastic resin is one that returns to the original elastomeric state thereof after being cooled without undergoing any chemical changes in the molecular structure during the process (for example, see “Dictionary of Chemistry, Reduced-Size Edition, Sixth Edition, compiled by the Editorial Committee of the Dictionary of Chemistry, KYORITSU SHUPPAN CO., LTD., pp. 860 and 867, 1963”).

The mass ratio of the thermoplastic resin in the melt-kneaded product is preferably 30 mass % or more and 48 mass % or less, more preferably 32 mass % or more and 45 mass % or less. If the mass ratio is 30 mass % or more, mechanical strength is easily ensured, and if it is 48 mass % or less, the water permeability performance is not compromised.

When the porous hollow fiber membrane of the present embodiment is a two-layer structure, the mass ratio of the thermoplastic resin in the melt-kneaded product for the layer (B), which is the layer forming the surface on the filtrate side, is preferably 34 mass % or more and 48 mass % or less, more preferably 35 mass % or more and 45 mass % or less. The mass ratio of the thermoplastic resin in the melt-kneaded product for the layer (A) is preferably 10 mass % or more and 35 mass % or less, more preferably 12 mass % or more and less than 35 mass %. If the mass ratio is 10 mass % or more, both good surface pore size and mechanical strength is achieved, and if the mass ratio is 35 mass % or less, reduction in the water permeability performance is prevented.

The organic liquid material serves as a latent solvent for the thermoplastic resin employed used in the present embodiment. In the present embodiment, a latent solvent is defined as a solvent that barely dissolves the thermoplastic resin at room temperature (25° C.), but can dissolve it at higher temperatures. It is sufficient for the solvent to be in liquid at the melt kneading temperature with the thermoplastic resin; it does not necessarily have to be liquid at room temperature.

The mass ratio of the organic liquid material in the melt-kneaded product is preferably 10 mass % or more and 70 mass % or less, more preferably 20 mass % or more and 60 mass % or less. If the mass ratio of the organic liquid material is 10 mass % or more, the thermoplastic resin can be dissolved stably, and if it is 70 mass % or less, the melt-kneaded product will have sufficient viscosity for the stable spinning of the porous membrane.

Examples of the inorganic fine powder include silica, alumina, titanium oxide, zirconium oxide, or calcium carbonate, with silica being preferred.

The average primary particle size of the inorganic fine powder is preferably 3 nm or more and 500 nm or less, more preferably 5 nm or more and 100 nm or less. Among these, fine silica with an average primary particle size of 3 nm or more and 500 nm or less is preferred. It is more preferable to use hydrophobic silica fine powder, which is less prone to aggregation and has good dispersibility, with hydrophobic silica with a methanol wettability (MW) value of 30% or more being more preferred.

The MW value as used herein refers to the percentage of methanol required to completely wet the powder. Specifically, this value is determined as follows: Silica is added to pure water, and methanol is added beneath the liquid surface while stirring. The value is defined as the volume percentage of methanol in the aqueous solution when 50 mass % of the silica has settled. The “average primary particle diameter of the inorganic fine powder” described above refers to the value obtained from the analysis of electron microscope images. Specifically, a batch of inorganic fine powder is pre-treated according to ASTM D3849 The diameters of 3,000 to 5,000 particles observed in transmission electron microscope images are measured. The arithmetic mean of these measurements is calculated to determine the average primary particle size.

Furthermore, the mass ratio of the inorganic fine powder in the melt-kneaded product is preferably 5 mass % or more and 50 mass % or less, more preferably 10 mass % or more and 40 mass % or less. If the mass ratio of the inorganic fine powder is 5 mass % or more, the benefits of kneading the inorganic fine powder will be sufficiently realized, and if it is 40 mass % or less, stable spinning can be achieved.

The mixture composed of the thermoplastic resin such as polyvinylidene fluoride and the organic liquid material, and mixture composed of the thermoplastic resin such as polyvinylidene fluoride, the organic liquid material, the inorganic fine powder can be obtained by mixing them using a Henschel mixer, Banbury mixer, Proshare mixer, or the like.

In terms of the order of mixing the three components, namely, the thermoplastic resin such as polyvinylidene fluoride, the organic liquid material, and the inorganic fine powder, it is advantageous to first mix the inorganic fine powder with the organic liquid material to allow sufficient adsorption of the organic liquid material onto the inorganic fine powder, and then blend and mix the thermoplastic resin such as polyvinylidene fluoride, in view of melt processability, and improvement of porosity and mechanical strength of the resulting porous membrane.

Alternatively, the thermoplastic resin such as polyvinylidene fluoride and the organic liquid material may be separately supplied into a melt-kneading extrusion apparatus such as a twin-screw extruder without performing preliminary mixing with a Henschel mixer or the like. In order to improve the kneadability, after mixing, melt-kneading can be performed once to pelletize the mixture, and these pellets can then be supplied to a melt-kneading extrusion apparatus, extruded into hollow fibers, which are subsequently cooled and solidified to form hollow fibers.

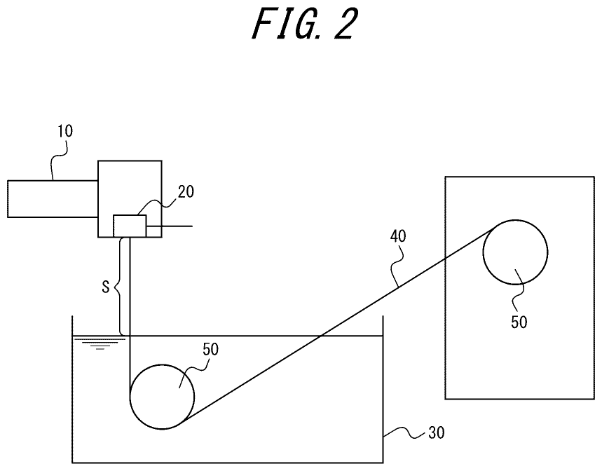

Melt kneading of the mixture can be performed using a conventional melt-kneading apparatus, such as extruders. The following describes the case when an extruder is used, but the method of melt kneading is not limited to the use of an extruder. One example of the manufacturing apparatus used in the production method of the present embodiment is illustrated in FIG. 2.

The manufacturing apparatus of porous hollow fiber membrane illustrated in FIG. 2 includes an extruder 10, a hollow fiber formation nozzle 20, a coagulation bath 30 containing the solution for solidifying the membrane-forming raw material, and multiple rollers 50 for transporting and winding the porous hollow fiber membrane 40. The space marked as “S” in FIG. 2 is the free travel section where the membrane-forming raw material, extruded from the hollow fiber formation nozzle 20, passes before reaching the solution in the coagulation bath 30.

The melt-kneaded product is extruded from the extruder 10 through the hollow fiber formation nozzle 20 equipped with one or more annular discharge outlets arranged concentrically, which is mounted on the tip of the extruder 10, and is discharged from the hollow fiber formation nozzle 20. There are several methods for manufacturing multilayer membranes. One method involves attaching a hollow fiber formation nozzle 20 with two or more concentric annular discharge outlets to the tip of the extruder 10, with each discharge outlet with melt-kneaded product from different extruders 10, and another method involves producing one layer and then applying the remaining layers. For example, in the former method using different extruders the melt-kneaded products fed to the discharge outlets are merged, thereby laminating them and forming a hollow fiber extrudate with a multilayer structure. In this case, by extruding melt-kneaded products with different compositions from annular discharge outlets adjacent to each other, a multilayer membrane with layers having different pore sizes can be obtained. “Different compositions” refers to cases where the ingredients of the melt-kneaded products are different or where the ingredients are the same but their ratios differ. Even when the same type of thermoplastic resin is used, if there is a clear difference in molecular weight or molecular weight distribution, the ingredients are considered different. The merging point of the melt-kneaded products with different compositions can be either at the bottom end of the hollow fiber formation nozzle 20 or at a position other than the bottom end of the hollow fiber formation nozzle 20.

When extruding the melt-kneaded product from the annular discharge outlet, it is preferable to set the spinning discharge parameter R (1/second) to a value of 10 or more and 1000 or less. This ensures high productivity, stable spinning, and the production of membranes with high strength and thus is preferred. Here, the spinning discharge parameter R is defined as the discharge line speed V (m/second) divided by the slit width d (m) of the discharge outlet. The discharge line speed V (m/second) is the value calculated by dividing the volume of the melt-kneaded product extruded per unit time (m³/second) by the cross-sectional area of the discharge outlet (m²). If R is 10 or more, the hollow extrudate can be spun stably with good productivity, without problems such as fluctuations in the fiber diameter. When R is 1000 or less, the resulting porous hollow fiber membrane maintains a sufficiently high elongation at break, which is one of the important strength properties of the membrane. Elongation at break refers to the percentage of elongation relative to the original length when the membrane is stretched in the longitudinal direction of the membrane.

In the case of a multilayer porous hollow fiber membrane, the discharge parameter R, defined as the discharge line speed V of the layered melt-kneaded product after the resins merge, divided by the slit width d of the discharge outlet, is more preferably 50 or more and 1000 or less.

The hollow fiber-like melt-kneaded product discharged from the discharge outlet is solidified by passing through a coolant such as air or water. Depending on the desired porous hollow fiber membrane, after passing through the above-described free travel section S composed of an air layer, the hollow fiber-like melt-kneaded product is made to pass through the coagulation bath 30 containing water or the like. That is, the free travel section S refers to the section from the discharge outlet of the hollow fiber formation nozzle 20 to the surface of the liquid in the coagulation bath 30. A container such as a tube may be used in the free travel section S, as needed, from the discharge outlet. After passing through the coagulation bath 30, the product may be reeled onto a spool or the like as needed.

The time taken for the melt-kneaded product to pass through the free travel section S is referred to as the “free travel time,” which is preferably 0.05 seconds or longer. A free travel time of 0.05 seconds or longer allows the polymer molecules to orient themselves in the free travel section, thereby further enhancing the compressive strength. The free travel time is more preferably 0.1 seconds or longer and 2.0 seconds or shorter. If the free travel time is 2.0 seconds or shorter, stable production can be achieved. The free travel time is preferably 0.12 seconds or longer and 1.0 seconds or shorter.

Additionally, when the temperature difference between the discharge temperature at the discharge outlet of the melt-kneaded product and the temperature in the coagulation bath 30 is defined as ΔT, and the free travel time is defined as t, it is preferable that the cooling rate ΔT/t is 105° C./s or more and 2100° C./s or less. When the cooling rate is 105° C./s or more, the phase separation rate increases, resulting in a shorter phase separation time. This makes it less likely for uneven stems to form, thereby improving the strength coefficient. The cooling rate is more preferably 210° C./s or more and 1750° C./s or less.

The coagulated hollow fiber-like extrudate contains polymer-rich phases and organic liquid material-rich phases, which are finely divided. For example, when the inorganic fine powder is added, if the inorganic fine powder is fine powder silica, the fine powder silica tends to concentrate more in the organic liquid material-rich phases. By extracting and removing the organic liquid material and the inorganic fine powder from the hollow fiber-like extrudate, the organic liquid material-rich phases become pores, resulting in a porous hollow fiber membrane.

The extraction and removal of the organic liquid material and the inorganic fine powder can be done simultaneously if they can be removed with the same solvent. Typically, they are extracted separately.

The extraction and removal of the organic liquid material is performed using a liquid suitable for extraction, which is miscible with the organic liquid material but does not dissolve or modify the thermoplastic resin used. Specifically, this extraction can be done by bringing the hollow fiber-like extrudate into contact with the liquid through immersion or other methods. The liquid is preferably volatile to facilitate easy removal from the hollow fiber membrane after extraction. Examples of the liquid include alcohols and methylene chloride. If the organic liquid material is water-soluble, water can also be used as the extraction liquid.

The extraction and removal of the inorganic fine powder is typically performed using a water-based liquid. For example, if the inorganic fine powder is silica, the silica can first be converted into silicate by contact with an alkaline solution, and then the silicate can be extracted by contact with water.

It does not matter which of the organic liquid material or the inorganic fine powder is extracted and removed first. If the organic liquid material is immiscible with water, it is preferable to first perform the extraction and removal of the organic liquid material, followed by the extraction and removal of the inorganic fine powder. Since the organic liquid material and the inorganic fine powder typically coexist in the organic liquid material-rich phase, the extraction and removal of the inorganic fine powder can proceed smoothly, which is advantageous.

By extracting and removing the organic liquid material and the inorganic fine powder from the solidified porous hollow fiber membrane in this manner, a porous hollow fiber membrane is obtained.

The solidified hollow fiber membrane can also be stretched in the longitudinal direction of the porous hollow fiber membrane at any of the following stages: (i) before the extraction and removal of the organic liquid material and the inorganic fine powder, (ii) after the extraction and removal of the organic liquid material and before the extraction and removal of the inorganic fine powder, (iii) after the extraction and removal of the inorganic fine powder and before the extraction and removal of the organic liquid material, or (iv) after the extraction and removal of the organic liquid material and the inorganic fine powder. The stretching can be performed within a range of the stretch ratio of 3 times or less.

In general, stretching the hollow fiber membrane in the longitudinal direction improves the water permeability performance thereof; however, the pressure resistance performances (e.g., burst strength and compressive strength) tend to decrease, often resulting in a membrane that lacks practical strength after stretching. However, the porous membrane (e.g., porous hollow fiber membrane) produced by the production method of the present embodiment has high mechanical strength.

Therefore, stretching at a stretch ratio of 1.1 times or more and 3.0 times or less is possible. Stretching improves the water permeability performance of the porous membrane (e.g., porous hollow fiber membrane). The stretch ratio as used herein refers to the length of the hollow fiber after stretching divided by the length before stretching. For example, if a porous hollow fiber membrane with a length of 10 cm is stretched to 20 cm, the stretch ratio is 2, calculated as follows:

$$20 cm / 10 cm = 2$$

Furthermore, it is preferable to stretch the hollow fiber membrane at a spatial temperature of 0° C. or higher and 160° C. or lower. If the temperature is higher than 160° C., the unevenness of stretching increases, and the elongation at break and water permeability performance decreases, which is undesirable. If the temperature is lower than 0° C., the likelihood of breakage during stretching increases, which is impractical. The spatial temperature during the stretching step is set to more preferably 10° C. or higher and 140° C. or lower, and even more preferably 20° C. or more and 100° C. or less.

In the present embodiment, it is preferable to stretch the hollow fiber membrane while it still contains the organic liquid material. Hollow fiber membranes containing the organic liquid material are less prone to breakage during stretching than those that do not contain the organic liquid material. Furthermore, hollow fiber membranes containing the organic liquid material can exhibit greater shrinkage after stretching, which increases flexibility in setting the shrinkage rate after stretching.

It is also preferable to stretch hollow fiber membranes containing the inorganic fine powder. Hollow fiber membranes containing the inorganic fine powder are less likely to collapse flat during stretching due to the stiffness of the hollow fiber membrane provided by the presence of the inorganic fine powder. Additionally, this helps prevent the pore sizes of the final hollow fiber membrane from becoming too small or the fiber diameters from becoming too thin.

In the present embodiment, it is even more preferable to stretch hollow fiber membranes containing both the organic liquid material and the inorganic fine powder.

For the reasons mentioned above, it is preferable to stretch the hollow fiber membrane containing either the organic liquid material or the inorganic fine powder, rather than stretching the hollow fiber membrane after the extraction is completed. Furthermore, it is more preferable to stretch the hollow fiber membrane containing both the organic liquid material and the inorganic fine powder, rather than stretching the membrane containing only one of the organic liquid material and the inorganic fine powder.

In addition, the method of subjecting the stretched hollow fiber membrane to the extraction has the advantage that the extraction solvent can more easily penetrate the interior of the hollow fiber membrane because the stretching increases the voids on the surface and inside of the hollow fiber membrane. Furthermore, the method of performing extraction after the stretching and subsequent shrinking step has the advantage that, as will be described later, the hollow fiber membrane with a low tensile modulus that can easily bend is obtained. This makes the hollow fiber membrane more prone to sway in the liquid flow if the extraction is performed in the liquid flow, which enhances the stirring effect and allows for highly efficient extraction in a shorter time.

In the present embodiment, when a step of stretching the hollow fiber membrane and followed by shrinking is included, a hollow fiber membrane with a low tensile modulus can be obtained as the final product. “Low tensile modulus” as used herein means that the fiber stretches easily with a small force and returns to the original shape thereof once the force is removed. A low tensile modulus allows the hollow fiber membrane to bend easily without collapsing flat, and the membrane can sway easily in the water flow during filtration. By causing the fibers to sway irregularly with the water flow, the layer of contaminants that would otherwise adhere and accumulate on the membrane surface does not grow and is easily removed, allowing the volume of filtrated water to be maintained at a high level. Furthermore, when the membrane is forcibly swayed through flushing or air scrubbing, the increased sway enhances the cleaning and recovery effect.

With regard to the degree of shrinkage of the fiber length during shrinking after stretching, the fiber length shrinkage ratio relative to the increase in the fiber length by stretching is preferably in the range of 0.3 or more and 0.9 or less. For example, if a 10 cm fiber is stretched to 20 cm and then shrunk to 14 cm, the fiber length shrinkage ratio can be calculated as 0.6 using the following formula:

$$Fiber length shrinkage ratio =$$

$$\{ ( maximum fiber length during stretching ) -$$

$$( fiber length after shrinkage ) / [ ( maximum fiber length during stretching ) -$$

$$( original fiber length ) ] = ( 20 - 14 ) / ( 20 - 10 ) = 0.6$$

If the fiber length shrinkage ratio is more than 0.9, the water permeability performance tends to decrease, and if it is less than 0.3, the tensile modulus tends to increase, which is undesirable. In the present embodiment, the fiber length shrinkage ratio is more preferably within the range of 0.50 or more and 0.85 or less.

Additionally, by adopting a step where the hollow fiber membrane is stretched to the maximum fiber length during stretching and then shrunk, the resulting hollow fiber membrane will not break when stretched to the maximum fiber length during use.

Here, when the stretching ratio is represented by X and the fiber length shrinkage ratio relative to the increase of the fiber length by stretching is represented by Y, the ratio Z, which indicates the degree of guarantee of elongation at break, can be defined by the following formula:

$$Z =$$

$$( maximum fiber length during stretching - fiber length after shrinkage ) /$$

$$fiber length after shrinking = ( XY - Y ) / ( X + Y - XY )$$

Z is preferably 0.2 or more and 1.5 or less, and more preferably 0.3 or more and 1.0 or less. If Z is too small, the guarantee of elongation at break will be insufficient. Conversely, if Z is too large, the risk of breakage during stretching increases, and the water permeability performance decreases.

Moreover, when the production method of the present embodiment includes a step of stretching and subsequent shrinking, the tensile elongation at break exhibits a significant reduction in breakage at low elongation, which narrows the distribution of tensile elongation at break.

The spatial temperature during the step of stretching and subsequent shrinking is preferably in the range of 0° C. or higher and 160° C. or lower, in view of the time required for shrinkage and the physical properties. Temperatures lower than 0° C. make the shrinkage too slow and thus impractical, while temperatures higher than 160° C. result in reduced elongation at break and decreased water permeability performance, which is undesirable.

In the present embodiment, the hollow fiber membrane preferably undergoes crimping during the shrinking step. This allows a hollow fiber membrane with a high crimp degree to be obtained without being crushed or damaged.

In general, hollow fiber membranes have a straight, tubular shape without bends. Thus, when they are bundled into a filtration module, there is a high possibility that the gaps between the hollow fibers cannot be maintained, leading to a fiber bundle with a low porosity.

In contrast, using hollow fiber membranes with a high crimp degree allows the individual fibers to bend, increasing the average spacing between the hollow fiber membranes and resulting in a fiber bundle with a high porosity. When a filtration module made of hollow fiber membranes with a low crimp degree is used, especially used in external pressure filtration, the limited spacing in the fiber bundle increases flow resistance and prevents effective filtration pressure from reaching the center of the fiber bundle. Additionally, during backwashing or flushing to remove accumulated deposits from the hollow fiber membranes, the cleaning effect inside the fiber bundle is reduced. A fiber bundle composed of hollow fiber membranes with a high crimp degree has a large porosity, and the spacing between the hollow fiber membranes is maintained even during external pressure filtration, thereby reducing the likelihood of uneven flow.

Therefore, the crimp degree of the hollow fiber membrane obtained through the production method of the present embodiment is preferably in the range of 1.5 or more and 2.5 or less. A crimp degree of 1.5 or more is preferable for the reasons mentioned above, and a crimp degree of 2.5 or less helps prevent a reduction in the filtration surface area per unit volume.

As an example of the crimping method for the hollow fiber membrane, during the step of stretching and subsequent shrinking, the hollow fiber membrane is reeled by passing the membrane between a pair of periodically grooved gear rolls or a pair of grooved sponge belts while allowing it to contract.

In addition, in the production method of the present embodiment, it is preferable to perform the stretching using a take-up device including a pair of opposing continuous track belts. In this case, take-up devices are used on both the upstream and downstream sides. In each take-up device, the hollow fiber membrane is held between the opposing belts, and the membrane is fed by moving both belts at the same speed and in the same direction. Furthermore, in this case, it is preferable to perform stretching by increasing the take-up speed on the downstream side relative to the upstream side. By performing stretching in this manner, it becomes possible to perform stretching without slipping under the stretching tension during stretching and to prevent the fibers from collapsing flat.

Here, the continuous track belt preferably includes a high-elasticity belt, such as a fiber-reinforced belt, on the inner side that contacts the drive roll, while the outer surface that contacts the hollow fiber membrane is made of an elastic material. Furthermore, it is preferable that the compressive elastic modulus of the elastic material in the thickness direction is 0.1 MPa or more and 2 MPa or less, and that the thickness of the elastic material is 2 mm or more and 20 mm or less. It is especially preferable that the outer surface is made of silicone rubber in view of chemical resistance and heat resistance.

The production method of the present embodiment further includes, after stretching the hollow fiber membrane, a multi-stage heat treatment step in which a heat treatment is performed at a temperature 50° C. to 40° C. lower than the melting point of the thermoplastic resin containing a polyvinylidene fluoride-based resin, followed by a heat treatment at a temperature 35° C. to 25° C. lower than the melting point of the thermoplastic resin.

By subjecting the stretched hollow fiber membrane to the heat treatments, the lamellar structure in the membrane can be altered, thereby improving the crystalline structure or mechanical properties. The heat treatment temperature refers to the temperature inside the heat treatment apparatus, and the temperature is preferably 50° C. to 10° C. lower than the melting point of the thermoplastic resin.

More specifically, the heat treatment temperature is preferably 100° C. or higher and 160° C. or lower, and more preferably 120° C. or higher and 150° C. or lower.

Additionally, the heat treatment time is preferably 1 hour or longer, and more preferably 3 hours or longer.

By conducting the heat treatments for a long time, the microcrystalline regions that fuse at low temperatures progressively disappear, resulting in a hollow fiber membrane with a thick lamellar structure (large crystal sizes) and a stable crystalline structure. The temperature profile can be a single-stage step with one temperature condition, but it is preferable to use a multi-stage step where a heat treatment is first conducted at a lower temperature, followed by a heat treatment at a higher temperature, within the above-described range.

The hollow fiber membrane of the present disclosure has the characteristic of being easily recrystallized at low temperatures. It is considered that the recrystallization of microcrystalline regions can be further promoted by adopting a multi-stage step that increases the temperature in a step-wise manner from a low temperature. The heat treatment method can be either batch-type or continuous-type.

In the production method of the present disclosure, although the inorganic fine powder is extracted and removed as described above, the presence of trace residuals can promote recrystallization in the microcrystalline regions. Although the detailed mechanism is unclear, it is presumed that the residual inorganic fine powder acts as nucleation points, promoting recrystallization.

Furthermore, it is preferable to conduct the heat treatment on the hollow fiber membrane after the extraction is completed, because this minimizes changes in fiber diameter, porosity, pore size, and water permeability performance.

### EXAMPLES

The following provides detailed descriptions with reference to examples and comparative examples; however, the present disclosure is not limited to these descriptions.

In examples, a molten raw material was first prepared, followed by the production of a porous hollow fiber membrane. The evaluations of membrane properties were conducted. The production conditions are as follows.

### Example 1

Vinylidene fluoride homopolymer (Kynar 720, manufactured by Arkema) was used as the thermoplastic resin. Pelletized Kynar 720 was cryogenically ground using a Linrex Mill (manufactured by Hosokawa Micron Corporation), then classified using a vibratory sieve to remove particles equal to or larger than 355 μm, thereby obtaining particles with a median diameter (d50) of 96 μm.

Next, 23.0 mass % of hydrophobic silica (AEROSIL R972, manufactured by Nippon Aerosil Co., Ltd.), 31.3 mass % of di(2-ethylhexyl) phthalate (DEHP, manufactured by CG Ester Corporation), 5.7 mass % of dibutyl phthalate (DBP, manufactured by CG Ester Corporation), and 40.0 mass % of the above-described vinylidene fluoride homopolymer were mixed. The resulting mixture was melt-kneaded using an extruder, and the molten mixture was extruded at 240° C. from a hollow fiber formation nozzle (outer diameter: 1.72 mm and inner diameter: 0.92 mm) attached to the tip of the extruder while supplying the air as a fluid to form the hollow portion.

The hollow fiber-like melt-kneaded product extruded at 240° C. was made to pass through the air for 0.24 seconds before being cooled and solidified in a coagulation bath filled with water at 25° C. The resultant was then drawn at a speed of 37 m/min by first take-up belts, made to pass through a first heating tank (0.8 m long) controlled at a spatial temperature of 40° C., stretched 2 times at a speed of 74 m/min by second take-up belts, made to pass through a second heating tank (0.8 m long) controlled at a spatial temperature of 140° C., shrunk 1.5 times at a speed of 55 m/min by third take-up belts and finally reeled onto a spool.

The resulting hollow fiber-like extrudate was immersed in methylene chloride at 30° C. for over 1 hour to extract and remove di(2-ethylhexyl) phthalate and dibutyl phthalate, followed by drying.

Next, the hydrophobic silica was extracted and removed as follows. The resultant was immersed in a 50 mass % ethanol aqueous solution for 30 minutes, followed by immersion in water for 30 minutes. It was then immersed in a 20 mass % sodium hydroxide aqueous solution at 70° C. for 1 hour. Then, it was repeatedly washed with water.

The resultant was then placed in a drying machine and a heat treatment was performed at a set temperature of 125° C. for 3 hours. The temperature was subsequently raised to 140° C., and a heat treatment was performed for 5 hours to obtain a sample of the porous hollow fiber membrane.

### Example 2

A sample of the porous hollow fiber membrane was produced using the same method as in Example 1, except that the outer diameter and the inner diameter of the hollow fiber formation nozzle were changed to 2.00 mm and 0.90 mm, respectively.

### Example 3

A sample of the porous hollow fiber membrane was produced using the same method as in Example 1, except that vinylidene fluoride homopolymer (Kynar 740, manufactured by Arkema) was used as the thermoplastic resin. After Kynar 740 was cryogenically ground, the median particle diameter (d50) of the classified particles was 93 μm.

### Example 4

A sample of the porous hollow fiber membrane was produced using the same method as in Example 3, except that the outer diameter and the inner diameter of the hollow fiber formation nozzle were changed to 2.00 mm and 0.90 mm, respectively.

### Example 5

A sample of the porous hollow fiber membrane was produced using the same method as in Example 1, except that the particles ground and classified in Examples 1 and 3 were mixed at a ratio of Kynar 720:Kynar 740=1:1 (mass ratio), which was used as the thermoplastic resin.

### Example 6

A sample of the porous hollow fiber membrane was produced using the same method as in Example 1, except that the particles ground and classified in Examples 1 and 3 were mixed at a ratio of Kynar720:Kynar 740=1:3 (mass ratio), which was used as the thermoplastic resin.

### Example 7

A sample of the porous hollow fiber membrane was produced using the same method as in Example 1, except that vinylidene fluoride copolymer (Kynar Flex 2850, manufactured by Arkema) was used as the thermoplastic resin. After Kynar Flex 2850 was cryogenically ground, the median particle diameter (d50) of the classified particles was 90 μm.

### Example 8

A sample of the porous hollow fiber membrane was produced using the same method as in Example 1, except that the particles ground and classified in Examples 1 and 7 were mixed at a ratio of Kynar720:Kynar Flex 2850=3:2 (mass ratio), which was used as the thermoplastic resin.

### Comparative Example 1

Vinylidene fluoride homopolymer (SOLEF 6010, manufactured by Solvay) was used as the thermoplastic resin. A sample of the porous hollow fiber membrane was prepared using the same method as in Example 1, except that SOLEF 6010 was used without being ground or classified because it is already in powder form.

### Comparative Example 2

Vinylidene fluoride homopolymer (KF W #1000, manufactured by Kureha Corporation) was used as the thermoplastic resin. A sample of the porous hollow fiber membrane was prepared using the same method as in Example 1, except that KF W #1000 was used without being ground or classified because it is already in powder form.

### Comparative Example 3

Vinylidene fluoride homopolymer (Kynar 761, manufactured by Arkema) was used as the thermoplastic resin. A sample of the porous hollow fiber membrane was prepared using the same method as in Example 1, except that Kynar 761 was used without being ground or classified because it is already in powder form.

The resulting samples of the porous hollow fiber membranes had improved compressive strength due to the increased molecular weights of the resulting polymers, but the samples did not achieve the desired pure water permeability or tensile elongation at break suitable for filtration applications.

### <Evaluations>

Each sample of the obtained porous hollow fiber membranes was evaluated using the following methods. Unless otherwise specified, measurements were performed at 25° C.

The measurement and evaluation results are summarized in Table 1.

### (1) Measurement of Inner Diameter, Outer Diameter, and Thickness

A hollow fiber membrane was thinly cut with a razor at 15 cm intervals perpendicular to the longitudinal direction of the membrane. The long diameter and short diameter of the inner diameter and the long diameter and short diameter of the outer diameter in the cross-sections were measured under a microscope, and the following formulas were used to calculate the results. This measurement was performed 10 times, and the average values for that condition were recorded as the inner diameter, outer diameter, and thickness.

$$Inner diameter ( mm ) = ( long inner diameter + short inner diameter ) / \\ Outer diameter ( mm ) = ( long outer diameter + short outer diameter ) / \\ Thickness ( mm ) = ( outer diameter - inner diameter ) / 2$$

### (2) Pure Water Permeability

A hollow fiber membrane was wetted by soaking it in a 50% ethanol aqueous solution for 30 minutes, followed by replacement with pure water. One end of the wetted hollow fiber membrane approximately 100 in length was sealed, and a syringe needle was inserted into the hollow portion at the other end. Pure water at 25° C. was injected into the hollow portion through the needle at a pressure of 0.1 MPa. The amount of water permeating through the outer surface was measured, and the pure water permeability was calculated using the following formula. The effective length of the membrane refers to the net length of the membrane excluding the portion where the syringe needle was inserted. This measurement was performed 10 times, and the average value was recorded as the pure water permeability for that condition.

$$Pure water permeability ( L / {m}^{2} / h ) =$$

$$volume of permeated water / ( π \times inner diameter of the membrane \times$$

$$effective length of the membrane \times measurement time )$$

Volume of permeated water (L), inner diameter of the membrane (m), effective length of the membrane (m), and measurement time (h)

### (3) Tensile Elongation at Break

The load and displacement at tensile break were measured under the following conditions.

The measurements were conducted in accordance with JIS K7161, using hollow fiber membranes as they were as the test specimens.
Measurement apparatus: table-top precision universal testing machine AGS-X (50N), manufactured by Shimadzu Corporation
Distance between chucks: 50 mm
Tensile speed: 200 mm/min

The tensile elongation at break was calculated from the obtained result in accordance with JIS K7161. This measurement was performed 10 times, and the average value was recorded as the tensile elongation at break for that condition.

### (4) Compressive Strength

One end of a wetted hollow fiber membrane approximately 5 cm in length was sealed, while the other end was left open to the atmosphere. Pure water at 40° C. was pressure-fed from the outer surface, and the permeated water was allowed to exit from the open end. At this time, the method so-called a total filtration method was employed, in which all of the water fed to the membrane was filtrated without recirculating it.

The applied pressure was gradually increased from 0.1 MPa in increments of 0.05 MPa, holding each pressure for 30 seconds. During this time, the permeated water exit from the open end was collected. When the hollow portion of the hollow fiber membrane did not collapse, the absolute value of the amount of the permeated water (in mass) increased as the applied pressure increased. However, if the applied pressure exceeded the compressive strength of the hollow fiber membrane, the hollow portion began to collapse, leading to blockage. As a result, despite the increase in applied pressure, the absolute value of the amount of the permeated water decreased. The applied pressure at which the absolute value of the amount of the permeated water reached its maximum was recorded as the compressive strength. This measurement was performed 10 times, and the average value was recorded as the compressive strength for that condition.

### (5) Chemical Resistance Test

A hollow fiber membrane approximately 100 mm in length was wetted by soaking it in a 50% ethanol aqueous solution for 30 minutes, followed by replacement with pure water.

Next, an aqueous solution containing 4.0 mass % sodium hydroxide and 2.0 mass % sodium hypochlorite in terms of effective chlorine concentration was prepared.

After the hollow fiber membrane was immersed in the aqueous solution at 25° C. for 17 days, a tensile test was conducted. The retention rate (%) of the elongation at break before and after the immersion was calculated. The tensile tests were performed with n=10, and the average value was calculated.

$$Retention rate ( \% ) = ( after immersion / before immersion ) \times 100$$

### (6) Temperature-Modulated Differential Scanning Calorimetry (MDSC)

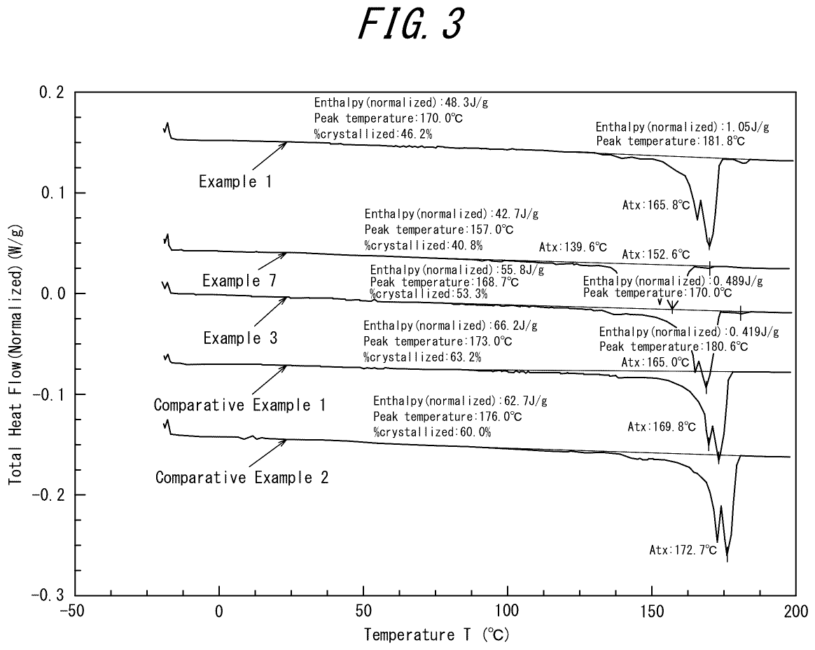

A 5 mg sample of a hollow fiber membrane was cut out, and an MDSC measurement was conducted under the following conditions to determine the crystal fusion temperature, enthalpy of crystal fusion, degree of crystallinity, etc., through total heat flow analyses. The results of the total heat flow analyses are illustrated in FIG. 3. The crystal fusion main peak refers to the peak with the largest endothermic area during heating. If a very small peak appeared once the endothermic value returned to the baseline upon further heating, it was determined that “a peak appeared after the main peak (Yes)”. If no such peak appeared, the result was determined “absent (No)”. For example, in the case of Example 1, the crystal fusion peak temperature of the main peak was 170.0° C., and the temperature of the peak appeared after the main peak was 181.8° C.

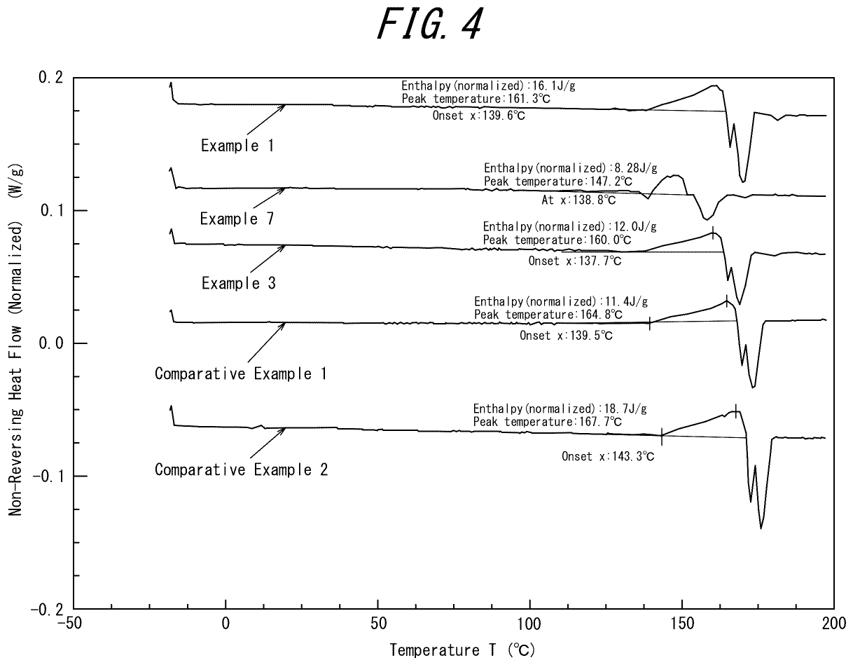

Additionally, the crystallization onset temperature was determined using non-reversing heat flow analyses. The results of the non-reversing heat flow analyses are illustrated in FIG. 4. The crystallization onset temperature was defined as the inflection point where the non-reversing heat flow clearly rose from the baseline during heating. For example, in the case of Example 1, the crystallization onset temperature was 139.6° C.
Apparatus: Discovery DSC2500 (manufactured by TA Instruments)
Atmosphere: Nitrogen, 50 mL/min
Sample pan: Tzero Aluminum
Measurement mode: Modulated Heat Only
Temperature range: −20° C.→200° C.
Heating rate: 1° C./min
Amplitude: 0.2° C.
Period: 60 s

Note that the degree of crystallinity was calculated as: degree of crystallinity=ΔH_{obs}/ΔH′ (ΔH′=105 J/g), where ΔH_{obs} is the enthalpy of crystal fusion observed through the total heat flow and Δ′ is the enthalpy of equilibrium fusion.

### (7) Percent of Reverse Units

A hollow fiber membrane (30 mg) was dissolved by adding 0.6 mL of deuterated DMF and heated at 50° C., and a 1H-NMR measurement was performed under the following conditions. The percent of reverse units was calculated using the following formula based on the integral values of the signals derived from the HT (head-to-tail) and HH (head-to-head) bonds of PVDF.
Apparatus: JEOL ECS 400
Pulse width: 45°
Waiting time: 3 seconds
Number of accumulations: 512 times

$$Chemical shift standard : CHO signals of DMF were defined \\ at 8.02 ppm * Percent of reverse units ( \% ) = HH / ( HH + HT )$$

### (8) Weight Average Molecular Weight (Mw)

A hollow fiber membrane was dissolved in DMF to a concentration of 1.0 mg/mL, and a GPC measurement was performed under the following conditions to determine the weight average molecular weight (in terms of PMMA).
Apparatus: HLC-8420 GPC (Tosoh Corporation)
   Column: TSKgel Guard column SuperAW-H, and
   TSKgel AWM-H (6.0 mm ID×15 cm)×2
Column temperature: 40° C.
Eluent: DMF containing 5 mM LiBr
Flow rate: 0.6 mL/min
Injection volume: 30 μL

TABLE 1

| | | | Exam- | Exam- | Exam- | Exam- | Exam- | Exam- | Exam- | Exam- | Comp. | Comp. | Comp. |
|---|---|---|---|---|---|---|---|---|---|---|---|---|---|
| | | Unit | ple 1 | ple 2 | ple 3 | ple 4 | ple 5 | ple 6 | ple 7 | ple 8 | Ex. 1 | Ex. 2 | Ex. 3 |
| (1) Sizes of porous | Outer | mm | 0.98 | 1.22 | 0.94 | 1.17 | 0.93 | 0.96 | 0.92 | 0.95 | 0.96 | 0.96 | 0.92 |
| hollow fiber membrane | diameter | | | | | | | | | | | | |
| | Inner | mm | 0.59 | 0.67 | 0.59 | 0.65 | 0.57 | 0.60 | 0.57 | 0.60 | 0.58 | 0.59 | 0.54 |
| | diameter | | | | | | | | | | | | |
| | Thickness | mm | 0.19 | 0.28 | 0.18 | 0.26 | 0.18 | 0.18 | 0.17 | 0.17 | 0.19 | 0.19 | 0.19 |

| | | | | | | | | | | | | |
|---|---|---|---|---|---|---|---|---|---|---|---|---|
| (2) Pure water permeability | L/m²/ | 7300 | 4900 | 4500 | 3300 | 6700 | 5900 | 2800 | 5600 | 5700 | 6400 | 2900 |
| | hr | | | | | | | | | | | |
| (3) Tensile elongation at break | % | 65 | 67 | 120 | 116 | 92 | 119 | 207 | 103 | 103 | 118 | 36 |
| (4) Anti-compression strength | MPa | 0.50 | 0.75 | 0.50 | 0.85 | 0.49 | 0.50 | 0.43 | 0.40 | 0.58 | 0.65 | 0.96 |
| (5) Retention rate of chemical | % | 72.2 | 70.5 | 68.0 | 69.0 | 70.1 | 69.0 | 81.6 | 75.9 | 53.7 | 58.8 | — |
| resistance | | | | | | | | | | | | |
| (6) Crystal fusion peak temperature | ° C. | 170.0 | 170.0 | 168.7 | 168.7 | 169.3 | 169.0 | 157.0 | 164.8 | 173.0 | 176.0 | — |
| of main peak | | | | | | | | | | | | |
| (6) Enthalpy of crystal fusion of | J/g | 48.3 | 48.3 | 55.8 | 55.8 | 52.1 | 53.9 | 42.7 | 46.1 | 66.2 | 62.7 | — |
| main peak | | | | | | | | | | | | |
| (6) Enthalpy of crystal fusion | J/g | 0.85 | 0.85 | 6.3 | 6.3 | 3.6 | 4.9 | 8.1 | 3.8 | 10.9 | 6.1 | — |
| below crystallization onset | | | | | | | | | | | | |
| temperature | | | | | | | | | | | | |
| (6) Proportion of crystal fusion | % | 1.8 | 1.8 | 11.2 | 11.2 | 6.8 | 9.1 | 19.0 | 8.1 | 16.5 | 9.8 | — |
| below crystallization onset | | | | | | | | | | | | |
| temperature | | | | | | | | | | | | |
| (6) Degree of crystallinity | % | 46.2 | 46.2 | 53.3 | 53.3 | 49.8 | 51.5 | 40.8 | 44.0 | 63.2 | 60.0 | — |
| (6) Initial crystallization temperature | ° C. | 139.6 | 139.6 | 137.7 | 137.7 | 138.7 | 138.2 | 138.8 | 139.3 | 139.5 | 143.3 | — |
| (6) Peak that appears after main peak | — | Yes | Yes | Yes | Yes | Yes | Yes | Yes | Yes | No | No | — |
| (6) Peak temperature of peak that | ° C. | 181.8 | 181.8 | 180.6 | 180.6 | 181.2 | 180.9 | 170.0 | 177.1 | No | No | — |
| appeared at temperatures higherthan | | | | | | | | | | | | |
| main peak | | | | | | | | | | | | |
| (6) Enthalpy of crystal fusion of peak | J/g | 1.1 | 1.1 | 0.4 | 0.4 | 0.7 | 0.6 | 0.5 | 0.8 | No | No | — |
| appearing at higher temperatures than | | | | | | | | | | | | |
| main peak | | | | | | | | | | | | |
| (6) Peak temperature appeared - main | ° C. | 11.9 | 11.9 | 11.9 | 11.9 | 11.9 | 11.9 | 13.0 | 12.3 | NG | NG | — |
| peak temperature | | | | | | | | | | | | |
| (7) Hetero-bond binding rate | % | 9.7 | 9.7 | 9.7 | 9.7 | 9.7 | 9.7 | — | — | 8.7 | 7.7 | — |
| (8) Molecular weight (Mw) | kDa | 230 | 230 | 380 | 380.0 | 305 | 343 | — | — | 320 | 290 | 560 |

It was found from the results in Table 1 and FIGS. 3 and 4 that the samples from each of the examples demonstrated superiority in a well-balanced manner in all evaluation items compared to the samples from the comparative examples.

It was found that the samples from the comparative examples demonstrated inferior results in at least one evaluation item compared to the samples from the examples.

### INDUSTRIAL APPLICABILITY

According to the present disclosure, it is possible to provide a porous hollow fiber membrane which is produced by the TIPS method, has high water permeability as well as blocking performance, and also exhibits high chemical resistance, allowing for continuous operation over a long period, and a method for producing a porous hollow fiber membrane.

1. A porous hollow fiber membrane made of a thermoplastic resin,
wherein a crystallization onset temperature is 140° C. or lower, and an enthalpy of crystal fusion at and below the crystallization onset temperature is 10 J/g or less.

2. The porous hollow fiber membrane according to claim 1, wherein the enthalpy of crystal fusion of the entire porous hollow fiber membrane is less than 58 J/g.

3. The porous hollow fiber membrane according to claim 1, wherein the enthalpy of crystal fusion of a peak appearing on a high temperature side of a crystal fusion main peak of the porous hollow fiber membrane is 0.1 J/g or more.

4. The porous hollow fiber membrane according to claim 1, wherein a temperature of the peak appearing on the high temperature side of the crystal fusion main peak of the porous hollow fiber membrane is at least 10° C. higher than a temperature of the crystal fusion main peak.

5. The porous hollow fiber membrane according to claim 1, wherein a degree of crystallinity of the porous hollow fiber membrane is less than 60%.

6. The porous hollow fiber membrane according to claim 2, wherein the enthalpy of crystal fusion at and below the crystallization onset temperature is 15% or less of the enthalpy of crystal fusion of the entire porous hollow fiber membrane.

7. The porous hollow fiber membrane according to claim 1, wherein a weight average molecular weight (Mw) of the thermoplastic resin is 400 kDa or less.

8. The porous hollow fiber membrane according to claim 1, wherein the thermoplastic resin comprises a polyvinylidene fluoride-based resin.

9. The porous hollow fiber membrane according to claim 1, wherein the porous hollow membrane has an inner diameter of less than 0.75 mm and a compressive strength of 0.3 MPa or more.

10. The porous hollow fiber membrane according to claim 1, wherein the porous hollow fiber membrane has a percent of reverse units of 9% or more.
